(19) United States
(12) Patent Application Publication
(10) Pub. No.: US 2026/0180503 A1
(43) Pub. Date: Jun. 25, 2026

(54) SYSTEMS AND METHODS FOR INDIRECTLY APPLYING SOLAR MATERIAL TO FORM A DEVICE DISPLAYING VIVID IMAGES

(71) Applicants: Toyota Motor Engineering & Manufacturing North America, Inc., Plano, TX (US); Toyota Jidosha Kabushiki Kaisha, Toyota-shi Aichi-ken (JP)

(72) Inventors: Songtao Wu, Ann Arbor, MI (US); Debasish Banerjee, Ann Arbor, MI (US); Brian K. Woods, Brighton, MI (US); Ryota Tomizawa, Shizuoka-ken Susono-shi (JP); Shinya Iwasaki, Mizuho City (JP)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/990,061

(22) Filed: Dec. 20, 2024

(51) Int. Cl. H02S 40/22; G02B 1/04; G02B 3/00; G09F 13/16; H02S 20/20; H02S 20/23; H02S 20/26

(52) U.S. Cl. CPC H02S 40/22; G09F 13/16; G02B 1/041; G02B 3/005; H02S 20/20; H02S 20/23; H02S 20/26

(57) ABSTRACT

Systems and methods described herein relate to displaying an image on a device capturing solar energy where a lens selectively directs light for energy capture and displays the image applied to a substrate that is bonded to the lens. In one embodiment, the system includes a lens that directs incident light within a first angular range for absorption and a second angular range for displaying an image. The system may also include viewing material applied to a substrate within predetermined areas and the viewing material forms the image. The system may also include absorption components applied to the substrate, the absorption components being located outside the predetermined areas, the absorption components capturing energy from the incident light within the first angular range, and the absorption components being hidden at the second angular range. The system may also include the substrate being bonded to the lens with a bonding material.

### TECHNICAL FIELD

The subject matter described herein relates, in general, to a system that displays an image while absorbing solar energy, and, more particularly, to a system having solar and viewing material forming the image on a substrate and a directional lens that selectively displays the image.

### BACKGROUND

Devices can capture and harvest solar energy to power other devices and buildings. Systems can also store energy for future usage. For instance, the systems have solar panels with photovoltaic material encapsulated in other materials (e.g., glass). Here, the photovoltaic material releases electrons and generates an electric charge when exposed to photons transmitted from the sun. Although the photonic energy is limited, the electric charge accumulates rapidly through solar panels that are sizable for powering devices such as consumer electronics, home lighting, and small appliances. In one approach, the electric charge generates a direct current (DC) for directly powering the devices. Furthermore, an inverter can transform the DC to alternating current (AC) for power outlets in a building depending upon regional safety codes. Output power from the devices capturing the solar energy is correlated with the size and density of the photovoltaic material. As such, systems having demanding power loads are impacted and limited by the size of photovoltaic material.

In various implementations, systems include an array of devices having photovoltaic material. Such arrays can be a farm that powers a neighborhood. Arrays having a limited size on a residential roof can power smaller homes. Still, these systems can exhibit poor appearances and aesthetics that limit installation sizes. Poor aesthetics and crude designs of solar arrays sometimes lead to bans by neighborhoods and towns for protecting property values. For example, zoning and commercial laws limit size and locations on buildings for solar installations. Art commissions and town engineers in historic areas can also require a permit to ensure conformity with existing exteriors and safety. Accordingly, systems powering devices using solar energy can produce increased power when having photovoltaic devices with aesthetics and designs allowing expanded installations.

### SUMMARY

In one embodiment, example systems and embodiments improve aesthetics by displaying an image on a device capturing solar energy where a lens selectively directs light for energy capture and displays the image applied to a substrate that is bonded to the lens. In certain implementations, systems using devices having photovoltaic material that harvest solar energy and power devices generate insufficient power. Causes of insufficient power are unattractive designs, aesthetics, and limited flexibility that constrain sizes associated with these devices. In other examples, roofing material (e.g., tiles) for commercial and residential applications attempt to hide solar arrays for aesthetics. However, these systems may reduce harvesting efficiency for energy by blocking and obstructing light. Furthermore, the appearances of these systems can be blurred and lack definition from manufacturing defects, thereby hindering adoption. Such systems can also exhibit rigid and inflexible properties that limit installations to flat surfaces.

Therefore, in one embodiment, a system has absorption components and viewing material applied to a substrate and a lens bonded to the substrate that selectively directs light for displaying an image formed with the viewing material while capturing energy. Here, the lens may pass the light to the absorption components (e.g., ink) at certain angles while directing the light to the viewing material at other angles. As such, the system improves aesthetics by hiding the absorption components at the certain angles. Furthermore, in one approach, the viewing material for the image and solar ink forming the absorption components are applied onto the substrate in different areas that exhibits an alternating pattern. Accordingly, the system improves aesthetics while maintaining efficient energy harvesting by displaying an image at certain viewing angles without obstructing incident light at other angles.

In one embodiment, a system for displaying an image on a device capturing solar energy where a lens selectively directs light for energy capture and displays the image applied to a substrate that is bonded to the lens is disclosed. In one embodiment, the system includes a lens that directs incident light within a first angular range for absorption and a second angular range for displaying an image. The system may also include viewing material applied to a substrate within predetermined areas and the viewing material forms the image. The system may also include absorption components applied to the substrate, the absorption components being located outside the predetermined areas, the absorption components capturing energy from the incident light within the first angular range, and the absorption components being hidden at the second angular range. The system may also include the substrate being bonded to the lens with a bonding material.

In one embodiment, a method for forming a component that displays an image on a device capturing solar energy where a lens selectively directs light for energy capture and displays the image applied to a substrate that is bonded to the lens is disclosed. The method may include applying viewing material by a printer to a substrate within predetermined areas, the viewing material forming an image. The method may also include applying by the printer solar ink directly to the substrate, the solar ink being located outside the predetermined areas, the solar ink capturing energy from incident light within a first angular range, and the solar ink being hidden at a second angular range. The method may also include bonding the substrate to a lenticular lens with a bonding material, the lenticular lens directing the incident light within the first angular range for absorption and the second angular range for displaying the image.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B illustrate embodiments of a system having a lens controlling light towards a substrate having components that absorb energy and viewing material and the system having flexible properties.

FIGS. 2A and 2B illustrate embodiments of a system having a lens selectively controlling light towards a substrate having components that absorb energy, viewing material, and reflective components and the system exhibiting flexible properties.

FIG. 3 illustrates an example of the system displaying an interlaced image applied on a substrate while absorbing solar energy using a lens that selectively directs incident light.

### DETAILED DESCRIPTION

Systems and other embodiments associated with displaying an image on a device capturing solar energy where a lens selectively directs light for energy capture and displays the image applied to a substrate that is bonded to the lens are disclosed herein. Systems for energy capture may utilize a solar layer having cells throughout the layer for energy capture. However, these systems can increase costs by wasting parts of the solar layer blocked by other layers and components. Furthermore, a solar layer composed of crystalline silicon can be rigid, thereby limiting installations to flatter surfaces. In another approach, systems using films can be more cost-efficient and lightweight than crystalline silicon systems. These systems can exhibit decreased efficiency and durability from bending compared to silicon panels. Films also can have aesthetic qualities that are undesirable making usage and size limited. Thus, systems using cells throughout a layer and crystalline silicon can encounter increased costs and decreased flexibility.

Therefore, in one embodiment, a system improves harvesting efficiency and aesthetics while reducing material costs by indirectly applying viewing material and absorption components to a substrate and bonding the substrate to a lens that controls incident light. In one approach, the lens is a transparent waveguide (e.g., a lenticular lens) that directs the incident light within a first angular range for absorption and a second angular range toward the viewing material. The absorption components can be solar ink printed to the substrate that absorbs light at the first angular range and otherwise are hidden at the second angular range. The substrate and lens can be fully flexible for applications involving curved form factors and uneven surfaces. Furthermore, the system can reduce materials costs by printing the solar ink and the viewing material in a juxtaposed pattern. As such, the solar ink exists in certain areas while the viewing material is located in other areas. In this way, the system reduces wasted materials from implementations having absorption cells that are blocked from incident light when existing throughout a layer.

In another approach, the system has reflective components (e.g., white ink) that are printed within areas of the substrate near the viewing material. Here, the reflective components can direct incident light within the second angular range towards the viewing material for improving reflectivity, clarity, and vividness. The absorption components being selectively located outside the areas, thereby reducing material costs. Furthermore, the substrate can be bonded to the lens using a bonding material (e.g., an optical adhesive). Accordingly, the system improves aesthetics through combining the viewing material and the reflective components while maintaining efficient energy harvesting by displaying an image at certain viewing angles without obstructing solar rays at other angles for energy capture.

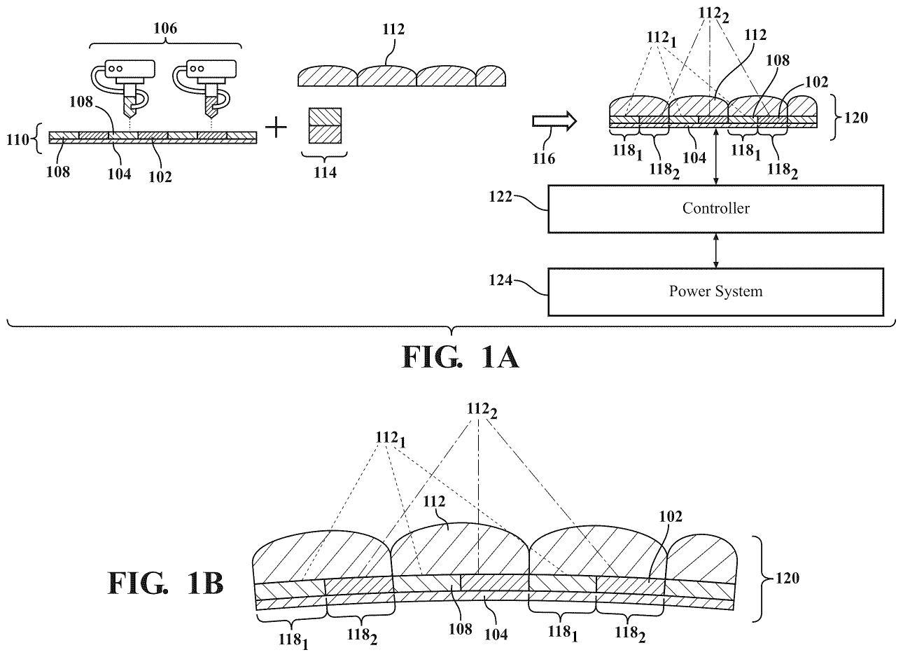

In certain implementations, the systems illustrated in FIGS. 1-3 also include various elements. It will be understood that in various embodiments, the systems may have less than the elements shown in FIGS. 1-3. The systems can have any combination of the various elements shown in FIGS. 1-3. Furthermore, the systems can have additional elements to those shown in FIGS. 1-3. In some arrangements, the systems may be implemented without one or more of the elements shown in FIGS. 1-3. While the various elements are shown as being located within the systems in FIGS. 1-3, it will be understood that one or more of these elements can be located external to the systems. Furthermore, the elements shown may be physically separated by large distances.

FIGS. 1A and 1B illustrate embodiments of a system having a lens controlling light towards a substrate having components that absorb energy and viewing material and the system having flexible properties. Here, the system may be installed on a building façade, a vehicle, billboard, etc., for absorbing solar energy at a first angular range while exhibiting viewing material 102 forming an image at a second angular range. A lens 112 can transmit and direct incident light within a first angular range 112₁ range for absorption and a second angular range 112₂ toward viewing material 102 on substrate 104. For example, the substrate 104 is flexible and formed with one of polyethylene terephthalate (PET), polyethylene terephthalate glycol (PET-G), acrylic, and polystyrene. In another approach, the substrate is a film that is flexible and transparent. Furthermore, an applicator 106 can apply the viewing material 102 and absorption components 108 to the substrate 104. In FIG. 1A, the applicator 106 can apply the viewing material 102 and the absorption components 108 in parallel, sequentially, or any other order.

The absorption components 108 capture energy from the incident light within the first angular range 112₁ while otherwise being completely hidden, partially hidden, etc., at the second angular range 112₂. In one approach, one or more of the absorption components 108 can form a cell capturing energy from incident light within the first angular range 112₁. Furthermore, subunits 118₁ and 118₂ can be areas associated with the lens 112. In another approach, the viewing material 102 is applied to the substrate 104 within subunits 118₂ while the absorption components 108 are located outside the subunits 118₂ within the subunits 118₁. This allows the system to efficiently capture solar energy from light at certain incident angles while displaying an image at other angles, thereby improving aesthetics and correspondingly expanding installation areas.

Moreover, the substrate 104 can be attached to the lens 112 through bonding 116 using bonding material 114, such as an optically clear adhesive. For instance, an optical adhesive that is clear enhances transparency that mitigates absorption losses for energy. In this way, the system improves appearances while maintaining energy benefits for a structure by absorbing energy at certain angles while displaying an image at other angles.

In other examples, angular ranges, bands, frequency ranges, etc., may be referenced as image bands that define angles at which the image (e.g., a black and white image, a color image, etc.) is viewable by a person, machine, etc. For example, the viewing material 102 mimics an object design, communicates a message, advertises information, replicates an exterior façade, replicates roofing material, etc. The image can be one of a color, grayscale, black and white, etc., image. Furthermore, the viewing material 102 and the second angular range 112₂ can together represent image bands within one of areas, sections, etc., of the lens 112 and form an image. As such, the absorption components 108 capture energy from the incident light within the first angular range 112₁ while being completely hidden, partially hidden, etc., at the second angular range 112₂ and the image being visible, thereby improving looks and designs.

The lens 112 can be a waveguide that optically controls and transmits incident light transparently toward the viewing material 102 and the absorption components 108. In one approach, the lens 112 is a lenticular layer, a lenticular film, a lenticular lens, etc., composed of PET that is fully flexible, transparent, and forms a waveguide that efficiently and clearly directs incident light towards the viewing material 102 and the absorption components 108. The lenticular layer can also be one of PET, PET-G, acrylic, and polystyrene.

In another approach, the lenticular film and the absorption film are thin films that adapt with a structural shape unlike crystalline silicon. A thin film can be a photovoltaic material such as cadmium telluride (CdTe), copper indium gallium diselenide (CIGS), etc., deposited on the substrate 104 and forming a solar cell in a layer. Thin films exhibit thinner profiles than wafers having crystalline silicon forming solar cells, thereby reducing weight and increasing flexibility. Material properties and design of the lens 112 allow controlling incident light such that certain angular ranges (e.g., bands) of the incident light travel through a transparent path to the absorption components 108, thereby increasing harvesting efficiency.

In another approach, the lens 112 is a lenticular waveguide with patterned features that controls and directs the transmission of incident light. The lenticular waveguide can be an array of lenses that allows the visibility of the viewing material 102 at certain angles and generates optical effects. For example, the lenticular waveguide gives an image depth at certain colors and wavelengths. In one approach, the lens 112 is a lenticular waveguide having pixels that form one or more images.

Regarding details about applying the absorption components 108 to the substrate 104, the system can utilize a general printer, thereby reducing costs. Applications demanding high-resolution and precision can involve applying the viewing material 102 and the absorption components 108 using a specialized printer. This approach can reduce ghosting and distortion from incident light being transmitted and absorbed by the absorption components 108 without interference, thereby improving image clarity.

The absorption components 108 printed to the substrate 104 and bonded to the lens 112 (e.g., a lenticular film) can be solar ink. Indirectly printing to the substrate 104 rather than directly to the lens 112 allows utilizing a general printer for the solar ink and the viewing material 102, thereby reducing equipment costs. In one approach, the solar ink comprises one of particles, flakes, etc., made from a film (e.g., a thin film). The solar ink can be perovskite-based that may be cured with ultraviolet (UV) light. This allows the solar ink to exhibit enhanced compatibility with various printers and printing methods. Furthermore, the substrate 104 can be bonded to the lens 112 using the bonding material 114, such as an optical adhesive that is clear. Similar to other examples, the viewing material 102 is located within subunits 118₂ while the absorption components 108 can be selectively located outside the subunits 118₂ within the subunits 118₁. For instance, the solar ink is independent and located outside the subunits 118₂. In this way, the solar ink absorbs energy at a first band while being out of sight and the image being visible at a second band. Thus, the solar ink and the viewing material 102 can form an alternating pattern, thereby reducing material costs through foregoing a full layer of the absorption components 108.

The absorption components 108 can be printed directly on the substrate 104 using the applicator 106 configured as specialized printer. The absorption components 108 can capture energy from the incident light within the first angular range 112₁. Otherwise, the absorption components 108 are completely hidden, partially hidden, etc., from sight and the viewing material 102 is visible by a viewer (e.g., a pedestrian). Here, the absorption components 108 can be hidden at the second angular range 112₂ and located outside the subunit 118₂ within the subunit 118₁. The system having the absorption components 108 limited to the subunit 118₁ rather than the length of the lens 112 saves material costs. For instance, the absorption components 108 is ink applied, printed, etc., to half the available areas on the substrate 104 within the first angular range 112₁, thereby saving material costs from printing along the entire substrate.

As illustrated by FIG. 1B, the lens 112 and the substrate 104 can combined as a device 120 to be fully flexible. For instance, the lens 112 and the substrate 104 comprise films that curve to form various shapes, such as a complete circle. In another approach, the lens 112 and the absorption components 108 (e.g., solar ink) fully curve to form a complete circle, a circular shape (e.g., 270-360 degrees), a polygon, etc. The fully flexible features benefit applications for a vehicle hood, roofs, a bus stop, advertising, etc. Furthermore, the flexibility of the device 120 expands applications and installation capabilities on curved roofs, shaded canopies, building components, lampposts, vehicle panels, vehicle rooftops, etc. Here, an image formed by the viewing material 102 is viewable at certain angles while solar rays transmit toward the absorption components 108 at other angles. Accordingly, the system improves the aesthetics of the building and other surfaces without obstructing solar rays, thereby increasing efficiency and power capture.

In various implementations, the viewing material 102 can form pixels for the image using ink that is cured through thermal, light, etc., treatment that improves system durability. Here, the pixels form an image viewable within certain angular ranges and transparent otherwise. In other words, the pixels are reflective since the image is viewable within the certain angular ranges. Regarding materials, the viewing material 102 may be ink, organic ink, pigment, organic pigment, etc., having optimal properties for improving visibility and clarity from a distance.

In FIG. 1A, the viewing material 102 and the absorption components 108 can be juxtaposed, alternating, etc. In various implementations, the absorption components 108 and the first angular range 112₁ represent an absorption band for harvesting solar energy. Furthermore, the lens 112 can be composed of waveguide units shaped as one of a hemisphere, a demilune, a triangle, etc. The lens 112 can be uniformly designed with various lens per inch in different areas through extrusion and rolling during manufacturing. The design can also have shapes to have various curvatures for adapting with different installations and application demands. As previously explained, areas associated with the lens 112 can be designated with subunits 118₁ and 118₂. The subunits 118₁ can represent an area having parts of the absorption components 108 applied to the substrate 104. The subunits 118₂ have the viewing material 102 applied to the areas, such using printing. Material and design properties of the lens 112 effect different angles of incident light directed to the subunits 118₁ and 118₂ for energy capture by the absorption components 108 and illuminating the viewing material 102.

The widths of the viewing material 102, the absorption components 108, the subunits 118₁ and 118₂ can vary depending upon demand for energy capture and visual design. For instance, the viewing material 102 has a first width X and the absorption components 108 near the viewing material 102 has a second width Y. For example, the first width X and the second width Y comprise one of a 1:1 ratio, a 2:1 ratio, a 3:1 ratio, and a 1:3 ratio. A person of ordinary skill in the art understands that systems herein can also implement any ratio. As such, the system can be designed where increasing X increases information delivery and sharpness while increasing Y increases energy capture.

The layers having the viewing material 102, the absorption components 108, and the substrate 104 in FIGS. 1-3 are illustrations. For instance, the viewing material 102 and the absorption components 108 have minimal thickness when applied to the substrate 104 in a layer. In this way, the component 110 is bonded evenly and flatly to the lens 112.

Regarding further details about applications, the device 120 can be integrated into a building for viewing an image while capturing solar energy. For example, the image displays one of an advertisement, an exterior façade, and roofing material. Here, solar rays at incident angles (e.g., 90-180 degrees) perpendicular to a building are transmitted toward the absorption components 108 by diffusing through the lens 112. The absorption components 108 can be mounted at an angle, vertically, etc. Furthermore, the device 120 displays a gray, blue, etc., image that mimics a façade at incident light (e.g., 0-90 degrees) from irradiation with reflected light. In other words, a pedestrian approaching the building sees an image, whereas the absorption components 108 directly absorb solar energy at certain incident angles by unobstructed transmission through the lens 112. This improves aesthetics for the absorption components 108 while increasing power capture through expanding installation capabilities. Besides mimicking an object design, the image may also communicate a message, advertising information, etc. In this way, the system increases available installation areas of systems for energy capture by attractive designs.

A controller 122 in FIG. 1A can regulate energy draw from the device 120 after bonding 116. The energy drawn is stored at power system 124. Similarly, a device, building, etc., can draw stored power from the power system 124. In various implementations, the controller 122 improves energy harvesting by adapting the orientation of the device 120 through different seasons using actuators. For example, an actuator tilts the device 120 ten degrees toward the equator during the wintertime for capturing additional light more directly. Accordingly, the controller 122 regulates power and enhances the capabilities of the device 120 through motion that improves energy harvesting.

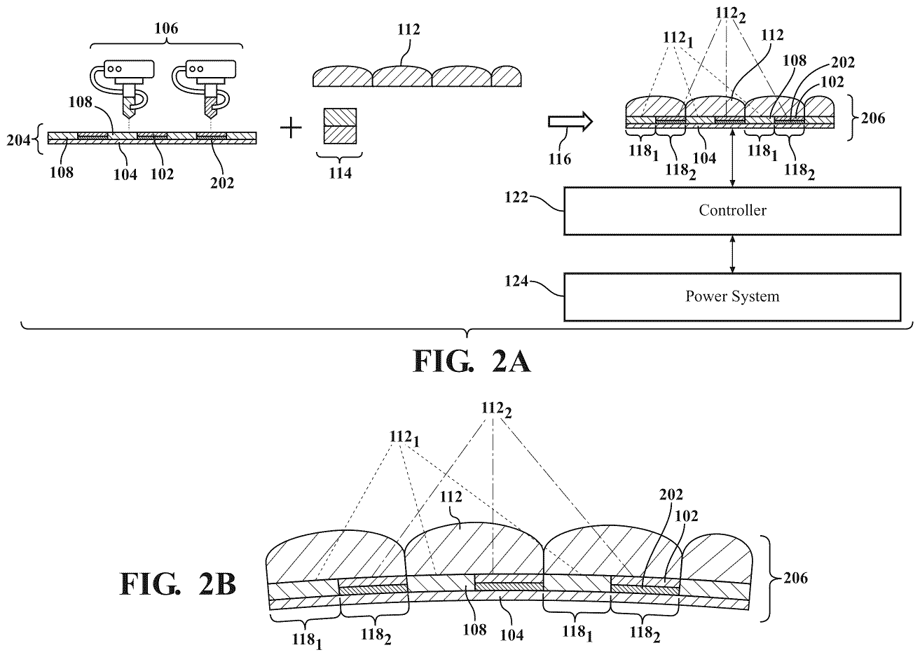

Now turning to FIGS. 2A and 2B, embodiments of a system having the lens 112 selectively controlling light towards the substrate 104 having components that absorb energy, the viewing material 102, and reflective components 202 and the system having flexible properties are illustrated. Certain components in FIGS. 2A and 2B may operate similarly or different than that described in FIGS. 1A and 1B. In FIG. 2A, the reflective components 202 can be applied within the areas indicated by the subunits 118₂ of the substrate 104 near the viewing material. The reflective components 202 direct the incident light within the second angular range 112₂ towards the viewing material 102 for improving brightness. The substrate 104 can reflect to absorption components 108 or transmit the incident light to other layers.

In one approach, the viewing material 102 and the reflective components 202 can be printed to the substrate 104. The reflective components 202 can be white and applied using a specialized printer that is high-resolution. Furthermore, the viewing material 102 and the reflective components 202 can be printed with the absorption components 108 to form a juxtaposed, alternating, etc., pattern among the subunits 118₁ and 118₂ (e.g., areas, sections, etc.). For instance, an alternating pattern effectively forms a lens cover that is angle-dependent and displays a colorful image.

The reflective components 202 near the viewing material 102 within the subunits 118₂ of the lens 112 can direct the incident light within the second angular range 112₂ towards the viewing material 102 to improve clarity and vividness. In one approach, the reflective components 202 are a bright color (e.g., white) that improve clarity and vividness for the viewing material 102 through blocking the absorption components 108 and the substrate 104 from absorbing incident light. Furthermore, the reflective components 202 increase reflectivity at the second angular range 112₂ for displaying colorful images and giving an attractive appearance. Vividness is also improved by reducing ghosting through shielding the incident light reflected off the absorption components 108 and the substrate 104. Accordingly, the system improves the aesthetics of the absorption components 108 and the substrate 104 by displaying images at certain viewing angles and at other angles directly guiding solar rays toward the absorption components 108.

Regarding further details about reflectivity, in one embodiment, the reflective components 202 direct and control unreflected light when the viewing material 102 has transparent characteristics and insufficient opaqueness. In one approach, the reflective components 202 prevent image distortion by containing light within the areas and preventing unintentional scattering. This also increases irradiation, reflectivity, and image vividness. For instance, the reflective components 202 insulate incident light from the absorption components 108 exhibiting darkness (e.g., black, deep blue, etc.). In other words, an image formed by the viewing material 102 can be distorted by light laterally absorbed from a color of absorption components 108 that otherwise would irradiate the image. Therefore, material with increased reflectivity redirects more incident light and reduces absorption by the absorption components 108, thereby reducing image distortion, improving image quality, and improving image resolution.

Dimensional properties of the reflective components 202 vary. Horizontally, the reflective components 202 can occupy a space per area without extruding and bleeding into the lens 112 after a predetermined quantity of printing passes. As such, the device 206 increases harvesting efficiency and reduces blurred images through physical properties having horizontal precision through controlled and adaptive printing. In another embodiment, the width of the reflective components 202 are congruent with the viewing material 102 through a controlled printing process that improves image contrast and sharpness.

Vertically, the reflective components 202 can occupy the space per area at a ratio with the viewing material 102 that improves thinness for the device 206. For instance, the device 206 exhibits deeper colors when a thickness of the viewing material 102 is equal to or greater than the reflective components 202 for producing deeper colors. A thickness ratio may also vary by each area of the image for exhibiting different visual effects. Similar to horizontal features, the device 206 can maintain precision and reduce costs through application within a limited number of printing passes (e.g., two, four, etc.). Printing passes continue until satisfying parameters for opaqueness between the viewing material 102 and the absorption components 108. For example, the parameter is that up to 99% of the incident light reflects for irradiance instead of being absorbed by the absorption components 108. Accordingly, the device 206 improves reflectivity while avoiding ghosting from optical distortion and interference.

The device 206 can increase performance by reflecting the incident light to the viewing material 102 while retaining the majority of the incident light. This improves aesthetics and energy capture. For example, the system generates above 90% reflectivity within a certain angular range from including the reflective components 202 rather than 10% reflectivity. For energy harvesting, the device 120 can reach above 90% retention instead of 80% through other implementations. Therefore, the device 206 displays an image with the viewing material 102 that makes the absorption components 108 aesthetically pleasing and flexible for increasing applications and available installation areas, thereby improving energy capture.

In FIG. 2A, the layers having the viewing material 102, the reflective components 202, the absorption components 108, and the substrate 104 are illustrations. For instance, the viewing material 102, the reflective components 202, and the absorption components 108 have minimal thickness when applied to the substrate 104 in a layer. In this way, the component 204 is bonded evenly and flatly to the lens 112. Furthermore, the widths of the viewing material 102, the reflective components 202, the absorption components 108, the subunits 118₁ and 118₂ can vary depending upon parameters for energy capture and visual quality. For example, the viewing material 102 and the reflective components 202 have a first width X and the absorption components 108 near the viewing material 102 have a second width Y. As another example, the first width X and the second width Y comprise one of a 1:1 ratio, a 2:1 ratio, a 3:1 ratio, and a 1:3 ratio. A person of ordinary skill in the art understands that systems herein can also implement any ratio. Thus, the system can be designed where increasing X increases sharpness and information content while increasing Y increases energy capture, thereby improving adaptability for meeting design goals.

Regarding FIG. 2B, the lens 112 and the substrate 104 can combine as a device 206 to be fully flexible. For instance, the lens 112 and the substrate 104 comprise films curving to form various shapes, such as a complete circle. In another approach, the lens 112 and the absorption components 108 (e.g., solar ink) fully curve to form a complete circle, a circular shape (e.g., 270-360 degrees), a polygon, etc. The fully flexible features benefit applications for a vehicle hood, roofs, a bus stop, advertising, etc. Furthermore, the flexibility of the device 206 expands applications and installation capabilities on curved roofs, shaded canopies, building components, lampposts, vehicle panels, vehicle rooftops, etc. Here, an image formed by the viewing material 102 is viewable at certain angles while solar rays transmit toward the absorption components 108 at other angles. Accordingly, an appearance and aesthetics of the system on building and other surfaces improve without obstructing solar rays, thereby increasing efficiency and power capture.

In various implementations, the applicator 106 forming the component 110 in FIG. 1A and the component 204 in FIG. 2A involves the following method, process, etc. The applicator 106 includes a printer for applying the viewing material 102 to the substrate 104 within predetermined areas defined by the subunits 118₁ and 118₂. Here, the viewing material 102 can be printed (e.g., directly printed) to the substrate 104 for forming an image. Furthermore, the method can include applying by the printer (e.g., directly printed) solar ink as the absorption components 108 to the substrate 104. For example, the solar ink is located outside the predetermined areas and captures energy from incident light within a first angular range 112₁. Meanwhile, the solar ink is hidden at a second angular range 112₂ through the lens 112 acting as a waveguide. In another approach, the method involves bonding the substrate 104 to the lens 112 (e.g., a lenticular lens) with a bonding material. For example, the lens 112 directs the incident light within a first angular range 112₁ for absorption and a second angular range 112₂ for displaying the image.

For component 204, the method further includes applying by the printer (e.g., directly printed) the reflective components 202 within the predetermined areas of the substrate 104 near the viewing material 102. As previously explained, the reflective components 202 can direct the incident light within the second angular range 112₂ towards the viewing material 102. For component 110 or component 204, the solar ink may comprise flakes, particles, etc., made from absorption film. Similar to other examples, the solar ink and the viewing material 102 can form an alternating, juxtaposed, etc., pattern. In this way, the method reduces wasted materials from implementations having absorption cells that are blocked from incident light when existing throughout a layer and improves aesthetics by displaying the image.

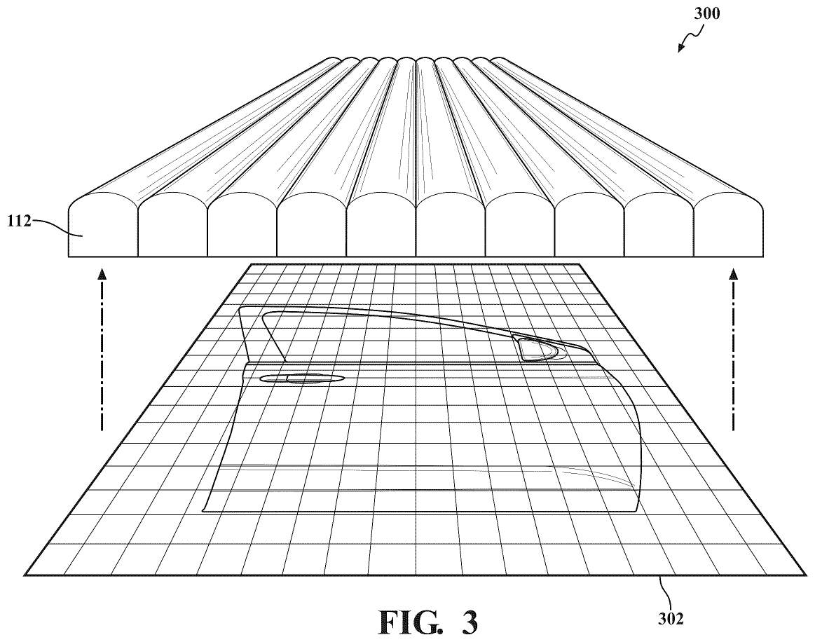

Concerning FIG. 3, system 300 illustrates an example of displaying an interlaced image 302 applied on a substrate while absorbing solar energy using the lens 112 that selectively directs incident light. Here, the interlaced image 302 can include printed pixels that exhibit different images from one or more angular ranges, thereby generating special effects. At a capture band, the system 300 absorbs energy from incident light by the lens 112 direct angular viewing ranges to absorption components such as solar ink. Thus, the system 300 improves aesthetics through combining the interlaced image 302, absorption components, and a lens that controls light transmission for special effects at certain viewing angles while maintaining efficient energy harvesting through avoiding light obstructions.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-3, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

1. A system comprising:
a lens that directs incident light within a first angular range for absorption and a second angular range for displaying an image;
viewing material applied to a substrate within predetermined areas, the viewing material forms the image;
absorption components applied to the substrate, the absorption components being located outside the predetermined areas, the absorption components capturing energy from the incident light within the first angular range, and the absorption components being hidden at the second angular range; and
the substrate is bonded to the lens with a bonding material.

2. The system of claim 1, wherein:
the absorption components are solar ink printed to the substrate, wherein the solar ink comprises particles made from a film and the solar ink and the viewing material form an alternating pattern; and
the viewing material is printed to the substrate.

3. The system of claim 2, wherein:
the lens and the substrate curve to form a complete circle; and
the image displays one of an advertisement, an exterior façade, and roofing material.

4. The system of claim 2, wherein the bonding material is an optical adhesive that is clear.

5. The system of claim 1 further comprising:
reflective components applied within the predetermined areas of the substrate near the viewing material, and the reflective components direct the incident light within the second angular range towards the viewing material; and
the viewing material and the reflective components are printed to the substrate.

6. The system of claim 1, wherein:
the viewing material has a first width and the absorption components near the viewing material have a second width; and
the first width and the second width comprise one of a 1:1 ratio, a 2:1 ratio, a 3:1 ratio, and a 1:3 ratio.

7. The system of claim 1, wherein:
the lens is a lenticular lens composed with one of a polymer and polyethylene terephthalate (PET) that forms a waveguide;
the substrate is formed with one of PET, polyethylene terephthalate glycol (PET-G), acrylic, and polystyrene material;
the lenticular lens and the substrate adapt to a structural shape; and
the lenticular lens is transparent and flexible.

8. The system of claim 1, wherein:
the lens and the substrate are a film and the film is flexible;
the substrate is transparent; and
the absorption components are solar ink made from perovskite-based material.

9. A system comprising:
a lenticular lens that directs incident light within a first angular range for absorption and a second angular range for displaying an image;
viewing material applied to a substrate within predetermined areas, the viewing material forms an image;
absorption components applied to the substrate, the absorption components being located outside the predetermined areas and the image being visible at the second angular range, the absorption components capturing energy from the incident light within the first angular range, and the absorption components being hidden at the second angular range; and
the substrate being bonded to the lenticular lens using a bonding material.

10. The system of claim 9, wherein:
the absorption components are solar ink directly printed to the substrate, wherein the solar ink comprises particles made from absorption film and the solar ink and the viewing material form a juxtaposed pattern; and
the viewing material is directly printed to the substrate.

11. The system of claim 10, wherein:
the lenticular lens and the substrate curve to form a complete circle; and
the image displays one of an advertisement, an exterior façade, and roofing material.

12. The system of claim 10, wherein the bonding material is an optical adhesive that is clear.

13. The system of claim 9 further comprising:
reflective components directly applied within the predetermined areas of the substrate near the viewing material, and the reflective components direct the incident light within the second angular range towards the viewing material; and
the viewing material and the reflective components are directly printed to the substrate.

14. The system of claim 9, wherein:
the viewing material has a first width and the absorption components near the viewing material have a second width; and
the first width and the second width comprise one of a 1:1 ratio, a 2:1 ratio, a 3:1 ratio, and a 1:3 ratio.

15. The system of claim 9, wherein:
the lenticular lens is composed with one of a polymer and polyethylene terephthalate (PET) that forms a waveguide;
the substrate is formed with one of PET, polyethylene terephthalate glycol (PET-G), acrylic, and polystyrene material;
the lenticular lens and the substrate adapt to a structural shape; and
the lenticular lens is transparent and flexible.

16. The system of claim 9, wherein:
the lenticular lens and the substrate are a film and the film is flexible;
the substrate is transparent; and
the absorption components are solar ink made from perovskite-based material.

17. The system of claim 9, wherein the substrate reflects and transmits the incident light.

18. A method comprising:
applying viewing material by a printer to a substrate within predetermined areas, the viewing material forming an image;
applying by the printer solar ink directly to the substrate, the solar ink being located outside the predetermined areas, the solar ink capturing energy from incident light within a first angular range, and the solar ink being hidden at a second angular range; and
bonding the substrate to a lenticular lens with a bonding material, the lenticular lens directing the incident light within the first angular range for absorption and the second angular range for displaying the image.

19. The method of claim 18 further comprising:
applying by the printer reflective components directly within the predetermined areas of the substrate near the viewing material, and the reflective components direct the incident light within the second angular range towards the viewing material.

20. The method of claim 18, wherein:
the solar ink comprises particles made from absorption film and the solar ink and the viewing material form a juxtaposed pattern; and
the viewing material is directly printed to the substrate.
